(19) United States
(12) Patent Application Publication
(10) Pub. No.: US 2017/0275138 A1
(43) Pub. Date: Sep. 28, 2017

(54) EMBEDDED ENERGY STORAGE TO DRIVE CAR AND AUXILIARY SYSTEMS

(71) Applicants: Aurélien FAUCONNET, Gien (FR); OTIS ELEVATOR COMPANY, Farmington, CT (US)

(72) Inventors: Aurelien Fauconnet, Isdes (FR); Gerard Sirigu, Gien (FR)

(21) Appl. No.: 15/504,136

(22) PCT Filed: Aug. 18, 2014
(86) PCT No.: PCT/IB14/02002

§ 371 Date: Feb. 15, 2017

(51) Int. Cl. B66B 11/00; B66B 1/30

(52) U.S. Cl. CPC B66B 11/0025; B66B 1/30; B66B 2201/40

(57) ABSTRACT

An elevator system includes a primary power source configured to generate a first power. An elevator car includes an energy sub-system embedded therein. The energy sub-system is in electrical communication with the primary power source to buffer the first power and to generate a second power for powering a drive sub-system that drives the elevator car.

### BACKGROUND OF THE INVENTION

The present disclosure relates generally to elevator systems, and more particularly, to energy sub-systems for an elevator system.

A typical elevator system includes an elevator car that moves along a hoistway. The elevator system includes an energy sub-system such as, for example, one or more batteries to provide electrical power to the elevator system. The electrical power can be utilized to drive the elevator car through the hoistway and/or power various auxiliary systems including, but not limited to, emergency power, emergency lighting, standard lighting, sound alerts, user interfaces, or the like.

Conventional energy sub-systems are typically located in the hoistway and are connected to the elevator car via electrical leads. As such, a technician must enter the hoistway to perform maintenance on the energy sub-system such as, for example, replacing one or more of the batteries. Entry into the hoistway requires that certain safety systems be in place, and that a specified safety volume and clearance space be provided for the technician. Regulatory bodies have specified necessary increases in safety volume and clearance for technicians entering the hoistway resulting in a larger overall volume of the elevator systems, while elevator system customers desire that the elevator system occupy a smaller overall volume. In addition, stopping elevator system operation to allow the technician to enter the hoistway and perform inspection and/or maintenance tasks is also time-consuming, costly, and inconvenient to riders.

### BRIEF DESCRIPTION

At least one embodiment provides an elevator system includes a primary power source configured to generate a first power. An elevator car includes an energy sub-system embedded therein. The energy sub-system is in electrical communication with the primary power source to buffer the first power and to generate a second power for powering a drive sub-system that drives the elevator car.

The elevator system includes the following additional features:

a feature wherein the energy sub-system includes at least one battery that is energized using the first power;

a feature wherein the elevator car includes an on-board compartment integrated therewith, wherein the energy sub-system is embedded within the on-board compartment;

a feature wherein the energy sub-system is configured to convert mechanical energy generated by the drive sub-system into electrical energy, and wherein the at least one battery is energized using the converted electrical energy;

a feature wherein the primary power source is a single-phase power supply;

a feature wherein the at least one battery drives the drive sub-system when the primary power source is disconnected from the energy sub-system;

a feature wherein the energy sub-system powers the drive sub-system and an auxiliary system of the elevator car, the auxiliary system including at least one of emergency power, emergency lighting, standard lighting, sound alerts, user interfaces, and door operation; and

a feature wherein the drive sub-system and the energy sub-system are commonly embedded within the on-board compartment.

Another embodiment provides an elevator car included in an elevator system. The elevator car includes an elevator car panel and an on-board compartment formed in the elevator car panel. The elevator car further includes an energy sub-system disposed within the on-board compartment. The energy sub-system is configured to power a drive sub-system of the elevator car.

The elevator car includes the following additional features:

a feature wherein the energy sub-system includes at least one battery that outputs the power for driving the drive-sub system;

a feature wherein the on-board compartment includes at least one removable portion that exposes the energy sub-system to an internal area of the elevator car;

a feature wherein the at least one battery is configured to be energized in response to receiving a second power from a primary power source remotely located from the elevator car;

a feature wherein the energy sub-system includes an energy recovery mechanism that is configured to convert mechanical energy received from the drive sub-system into electrical energy, and wherein the at least one battery is configured to be energized in response to receiving the converted electrical energy from the energy recovery mechanism;

a feature wherein the energy sub-system detects disconnection of the primary power source and powers the drive sub-system using only the power output from the at least one battery; and

a feature wherein the energy sub-system powers the drive sub-system and an auxiliary system of the elevator car, the auxiliary system including at least one of emergency power, emergency lighting, standard lighting, sound alerts, user interfaces, and door operation.

### BRIEF DESCRIPTION OF THE DRAWINGS

FIG. 1 is a block diagram illustrating an elevator car including an embedded energy sub-system for powering an elevator system according to an embodiment;

FIG. 2 is a close-up view of an elevator car including an on-board compartment for supporting an embedded energy sub-system according to an embodiment; and

FIGS. 3A and 3B illustrate an embedded energy sub-system embedded in an on-board compartment of an elevator car according to an embodiment.

### DETAILED DESCRIPTION OF THE INVENTION

At least one embodiment described by the present disclosure provides an elevator car including an embedded energy sub-system for powering an elevator system. The embedded energy sub-system is configured to drive the elevator car along a hoistway. The embedded energy sub-system may also power one or more auxiliary systems of the elevator car including, but not limited to, emergency power, emergency lighting, standard lighting, sound alerts, user interfaces, door operation, or the like.

The energy sub-system can be formed as one or more batteries that can be loaded using a primary power source formed as single-phase power supply. Since the energy sub-system is embedded in the elevator car, a technician can perform maintenance and inspection of the energy sub-system from within the elevator car without the need to enter the hoistway. Therefore, various required volume and clearance regulations, such as clearance between the elevator car and the dimensions of the hoist, may be satisfied. Moreover, the capability of driving the elevator car and auxiliary systems using one or more batteries allows the elevator system to be powered using a lower voltage power as compared to conventional elevator systems. Moreover, one or more batteries of the embedded energy sub-system can allow the elevator system to continue operating if power is no longer output from the primary power source.

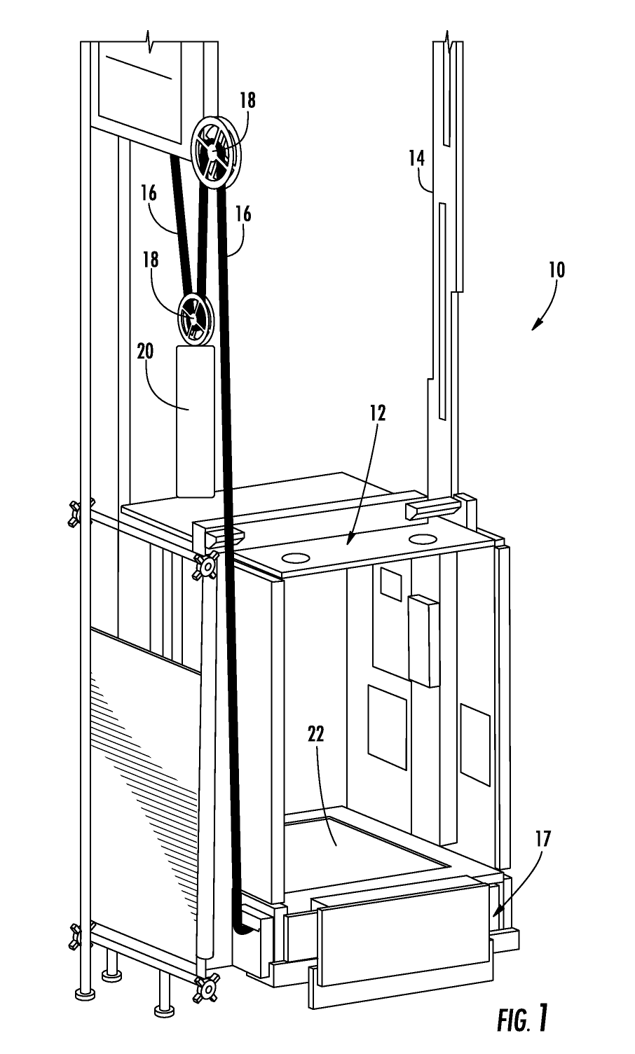

Referring now to FIG. 1, an elevator system 10 is illustrated according to an embodiment. The elevator system 10 includes an elevator car 12 operatively suspended or supported in a hoistway 14 using one or more suspension members 16, such as ropes or belts.

The elevator car includes an accessible on-board compartment 17 configured to support one or more sub-systems of the elevator system 10. The sub-systems include, but are not limited to, an energy sub-system, a drive sub-system, and a braking sub-system as understood by one of ordinary skill in the art.

The one or more suspension members 16 interact with one or more external sheaves 18 to be routed around various components of the elevator system 10. The one or more external sheaves 18 could also be connected to a counterweight 20, which is used to help balance the elevator system 10 and adjust the tension realized by the suspension members 16. The external sheaves 18 each have a diameter, which may be the same or different than the diameters of the other external sheaves 18 in the elevator system 10.

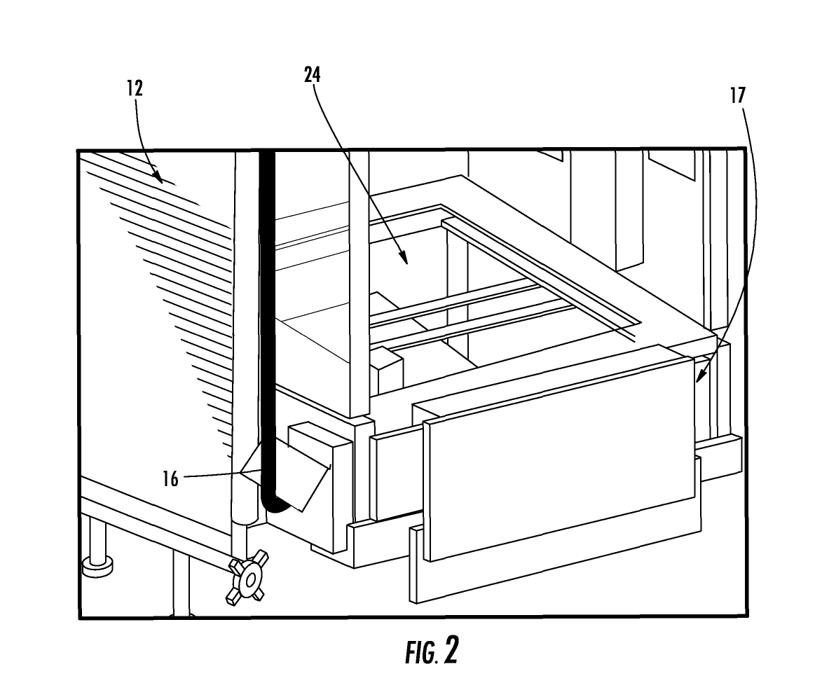

The on-board compartment 17 can be formed in a panel of the elevator car 12 such as, for example, the flooring of the elevator car 12 and can be accessed via a removable cover or door 22. Referring to FIG. 2, for example, the on-board compartment 17 is illustrated with the cover 22 removed to allow access to the internal area 24 of the on-board compartment 17. Although the on-board compartment 17 is illustrated as being located in the flooring of the elevator car 12, it is appreciated, however, that other embodiments of the present disclosure allow for the on-board compartment 17 to be formed at various other locations of the elevator car 12 including, but not limited to, the sidewall panels and the ceiling.

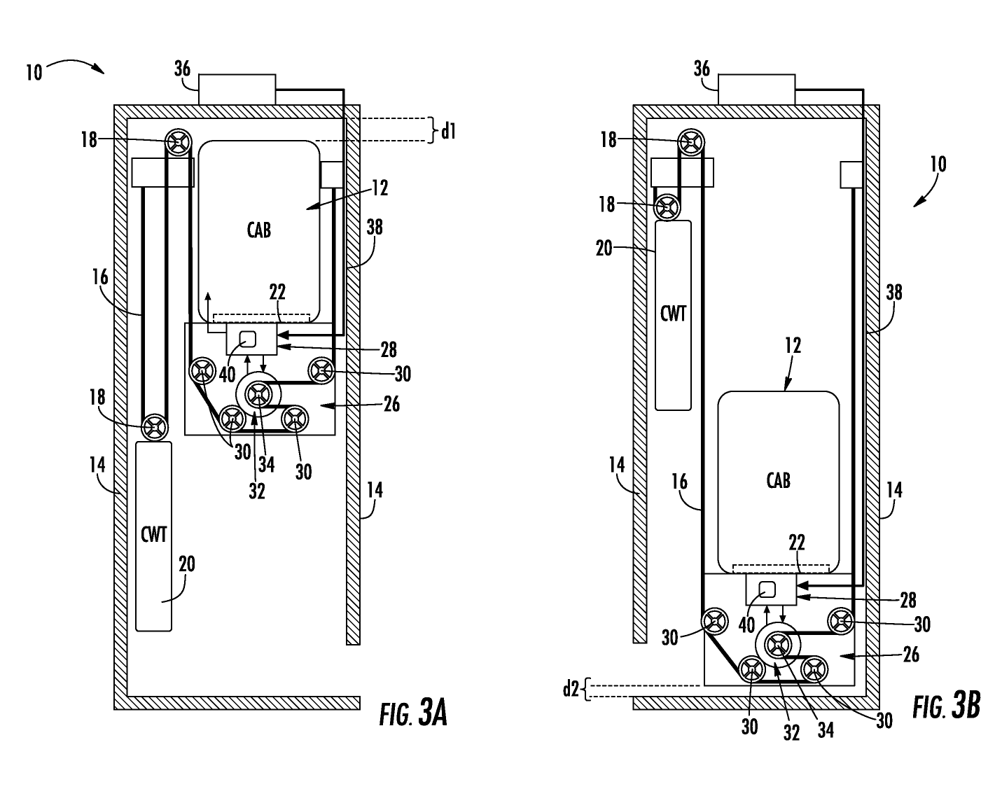

Referring now to FIGS. 3A-3B, the on-board compartment 17 can contain an embedded drive sub-system 26 and/or an embedded energy sub-system 28. Although the embedded drive sub-system 26 and the embedded energy sub-system 28 are illustrated as being disposed in the same on-board compartment 17, it is appreciated that the embedded energy sub-system 28 can be disposed within the on-board compartment 17 independently from the embedded drive-sub-system. In this manner, electromagnetic noise interference may be reduced. In either instance, the on-board compartment 17 allows for clearance (d1/d2) between the elevator car 12 and the hoist 14 to be reduced.

The embedded drive sub-system 26 includes a plurality of internal sheaves 30 and a machine 32. The internal sheaves 30 receive the suspension member 16 and routes the suspension member 16 within the internal area of the on-board compartment so that it interacts with a drive sheave 34 that is coupled to the machine 32. At least one of the internal sheaves 30 can be a diverter, deflector or idler sheave. Diverter, deflector or idler sheaves are not driven by the machine 32, but help guide one or more of the suspension members 16 around the various components disposed within the on-board compartment 17. The drive sheave 34 is driven by the machine 32, which receives power from the energy sub-system 28. Movement of the drive sheave 34 by the machine 32 drives, moves and/or propels (through traction) one or more of the suspension members 16 along the path defined by the external sheaves 18 and the internal sheaves 30.

The embedded energy sub-system 28 is formed as, for example, one or more batteries, and is configured to buffer energy necessary for driving the elevator car 12 and powering the auxiliary systems. According to an embodiment, one or more batteries of the energy-sub system 28 may be connected to a primary power source 36 via a power connection 38. The one or more batteries include, for example, a lithium ion battery that is disposed within the on-board compartment 17. According to an embodiment, the primary power supply 36 receives an input power from a building power source. The building power source may include, for example, a three-phase power supply. In this case, a building connection, such as three power cables corresponding to the three-phase building power, can provide power to the primary power supply 36.

According to a non-limiting embodiment, the primary power source 36 is formed as a single-phase power supply configured to generate approximately 220 volts (V). In this manner, one or more batteries of the embedded energy sub-system 28 can be loaded (i.e., energized) using a reduced amount of power ranging, for example, from approximately 1 kilowatt (kW) to approximately 5 kW. In addition, the energy sub-system 28 may include an energy recovery mechanism 40 that is configured to convert mechanical energy into electrical energy as understood by one of ordinary skill in the art. In this manner, energy generated by the embedded drive sub-system 26 may be captured, converted into electrical energy, and fed back to the embedded energy sub-system 28 to load and energize the batteries. The capability of driving the elevator car 12 and auxiliary systems using the one or more batteries of the embedded energy sub-system 28 allows the elevator system 10 to continue operating if power is no longer output from the primary power source 36. According to an embodiment, for example, the embedded energy sub-system 28 may detect when the primary power source is disconnected. In response to detecting the disconnect, the embedded energy sub-system 28 may begin powering the drive sub-system and/or the auxiliary systems using only the batteries and may continue re-energizing the batteries using the electrical energy generated in response to converting the mechanical energy output by the embedded drive sub-system 26.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An elevator system, comprising:
a primary power source configured to generate a first power;
an elevator car including an energy sub-system embedded therein, the energy sub-system being in electrical communication with the primary power source to buffer the first power and to generate a second power for powering a drive sub-system that drives the elevator car.

2. The elevator system of claim 1, wherein the energy sub-system includes at least one battery that is energized using the first power.

3. The elevator system of claim 2, wherein the elevator car includes an on-board compartment integrated therewith, wherein the energy sub-system is embedded within the on-board compartment.

4. The elevator system of claim 3, wherein the energy sub-system is configured to convert mechanical energy generated by the drive sub-system into electrical energy, and wherein the at least one battery is energized using the converted electrical energy.

5. The elevator system of claim 4, wherein the primary power source is a single-phase power supply.

6. The elevator system of claim 5, wherein the at least one battery drives the drive sub-system when the primary power source is disconnected from the energy sub-system.

7. The elevator system of claim 6, wherein the energy sub-system powers the drive sub-system and an auxiliary system of the elevator car, the auxiliary system including at least one of emergency power, emergency lighting, standard lighting, sound alerts, user interfaces, and door operation.

8. The elevator system of claim 7, wherein the drive sub-system and the energy sub-system are commonly embedded within the on-board compartment.

9. An elevator car included in an elevator system, the elevator car comprising:
an elevator car panel;
an on-board compartment formed in the elevator car panel; and
an energy sub-system disposed within the on-board compartment, the energy sub-system configured to power a drive sub-system of the elevator car.

10. The elevator car of claim 9, wherein the energy sub-system includes at least one battery that outputs the power for driving the drive-sub system.

11. The elevator car of claim 10, wherein the on-board compartment includes at least one removable portion that exposes the energy sub-system to an internal area of the elevator car.

12. The elevator car of claim 11, wherein the at least one battery is configured to be energized in response to receiving a second power from a primary power source remotely located from the elevator car.

13. The elevator car of claim 12, wherein the energy sub-system includes an energy recovery mechanism that is configured to convert mechanical energy received from the drive sub-system into electrical energy, and wherein the at least one battery is configured to be energized in response to receiving the converted electrical energy from the energy recovery mechanism.

14. The elevator car of claim 13, wherein the energy sub-system detects disconnection of the primary power source and powers the drive sub-system using only the power output from the at least one battery.

15. The elevator car of claim 14, wherein the energy sub-system powers the drive sub-system and an auxiliary system of the elevator car, the auxiliary system including at least one of emergency power, emergency lighting, standard lighting, sound alerts, user interfaces, and door operation.
